(19) United States
(12) Patent Application Publication
(10) Pub. No.: US 2008/0297662 A1
(43) Pub. Date: Dec. 4, 2008

(54) Method and system for optimizing mobile electronic device performance when processing video content

(76) Inventor: Benjamin K. Gibbs, Camas, WA (US)

Correspondence Address: SHARP LABORATORIES OF AMERICA, INC., 1320 PEARL ST., SUITE 228, BOULDER, CO, 80302, US

(21) Appl. No.: 11/809,668

(22) Filed: Jun. 1, 2007

(51) Int. Cl. H04N 5/44; H04M 1/00

(52) U.S. Cl. 348/725; 455/556.2; 348/E05.096

(57) ABSTRACT

A method and system for optimizing performance of a mobile electronic device when processing video content through reduced reliance on software processing by the mobile electronic device in making luminance adjustments to the video content. Software processing by the mobile electronic device is reduced by having a video server node preprocess video content and determine luminance adjustments adapted to optimize mobile electronic device performance when rendering the video content. Software processing by a mobile electronic device is further reduced by having a software-driven processor on the mobile electronic device apply luminance adjustment identifiers received from the video server node to select and load onto a display driver integrated circuit on the mobile electronic device lookup tables having values adapted for application to adjust luminance of the segments of the video content as rendered.

### BACKGROUND OF THE INVENTION

The present invention relates to mobile electronic device performance optimization and, more particularly, to a method and system for optimizing mobile electronic device performance when processing and displaying video content.

Many modern mobile electronic devices, such as cellular phones, digital audio/video players and personal data assistants (PDA), are capable of rendering on a liquid crystal display (LCD) panel of the device video content downloaded from a video server node over a communication network. For example, some Mobile TV services deliver prerecorded and live television programs that are rendered on an LCD panel of cellular phones.

Video content downloaded from a video server node to a mobile electronic device often has luminance settings optimized for viewing the video content on a cathode ray tube (CRT) or LCD television screen. To optimize the video content for viewing on a mobile electronic device LCD panel, it is known to perform on the device a gamma correction that adjusts the luminance of the video content.

Additionally, rendering video content downloaded from a video server node on a mobile electronic device often requires sustained use of several components of the device, including a memory, a processor, a wireless interface, an LCD panel and an LCD backlight. The LCD backlight is typically positioned behind the LCD panel and radiates light through the LCD panel to increase the brightness of the video content being rendered on the LCD panel as perceived by the user. Reducing the power consumed by any of these components when rendering video content is desirable to conserve the battery life of the device and thereby enable longer viewing times for video content and increase the availability of power for other uses, such as making phone calls. To optimize power consumption when rendering video content on the mobile electronic device LCD panel, it is known to employ on the device a technique called adaptive backlighting. Generally speaking, adaptive backlighting decreases luminance of the LCD backlight while maintaining brightness of the rendered video content as perceived by the user. This may be accomplished, for example, by increasing luminance of the video content being rendered on the LCD panel and correspondingly reducing luminance of the LCD backlight, or by identifying times in the video content that are dim or dark and reducing luminance of the LCD backlight during those times.

While these optimization techniques performed on the mobile electronic device have improved overall mobile electronic device performance when rendering video content, there is room for improvement. For example, these optimization techniques have relied heavily on software processing by the device. In a Mobile TV system, for example, video content is streamed from a video server node to a mobile electronic device via a point-to-point, point-to-multipoint or broadcast link. Known implementations of adaptive backlighting have relied on software on the device to examine individual frames and pixels of the streamed video content and determine from this examination a luminance adjustment for the video content and LCD backlight that will conserve power while maintaining brightness of the rendered video content as perceived by the user. The processing power consumed executing these software operations on a “per frame, per pixel” basis has reduced the power savings realized through the luminance adjustments.

### SUMMARY OF THE INVENTION

The present invention, in a basic feature, provides a method and system for optimizing performance of a mobile electronic device when processing and displaying video content through reduced reliance on software processing by the device in making luminance adjustments to the video content. Performance optimization manifests itself, for example, in terms of improved power conservation on the mobile electronic device.

In one aspect of the invention, software processing by the mobile electronic device is reduced by having a video server node preprocess video content and determine luminance adjustments adapted to optimize mobile electronic device performance when rendering the video content. By offloading such luminance adjustment determinations from a mobile electronic device that receives the video content to a video server node that delivers the video content, power requirements on the mobile electronic device when processing video content are substantially reduced.

In another aspect of the invention, software processing by a mobile electronic device is reduced by having a software-driven processor on the mobile electronic device apply luminance adjustment identifiers received from the video server node for video content segments to select and load onto a display driver integrated circuit on the mobile electronic device lookup tables having values adapted for application by the display driver integrated circuit to adjust luminance of the video content segments as rendered. By offloading such luminance adjustment applications from a software-driven processor on a mobile electronic device to a display driver integrated circuit on the mobile electronic device, power requirements on the mobile electronic device when processing video content are even further reduced. Moreover, transmitting from the video server node to the mobile electronic device luminance adjustment identifiers that are adopted for application on the mobile electronic device to select lookup tables, rather than transmitting the entire contents of lookup tables, can dramatically reduce the volume of data transmitted from the video server node to the mobile electronic device and thereby conserve substantial network bandwidth.

The method and system for optimizing performance of a mobile electronic device when processing video content of the present invention offer other and further advantages in terms of, for example, increased compatibility between video server nodes and mobile electronic devices and reduced complexity of mobile electronic device software.

In some embodiments of the invention, a mobile electronic device comprises a wireless interface; a processor adapted to execute software instructions; and a display driver integrated circuit, wherein the processor is adapted to receive via the wireless interface a luminance adjustment identifier, apply the luminance adjustment identifier to select a data set from a plurality of preconfigured data sets and load the selected data set into a lookup table on the display driver integrated circuit, and wherein the display driver integrated circuit is adapted to apply at least one value from the loaded data set to adjust luminance of video content as rendered on a display panel of the mobile electronic device.

In some embodiments of the invention, a method for optimizing performance of a mobile electronic device when processing video content comprises the steps of receiving a luminance adjustment identifier; selecting a data set from a plurality of preconfigured data sets based at least in part on the luminance adjustment identifier; loading the selected data set into a lookup table on a display driver integrated circuit; and determining by the display driver integrated circuit luminance of video content as rendered on a display panel based at least in part on a value from the loaded data set.

In some embodiments of the invention, a method for optimizing performance of a mobile electronic device when processing video content comprises the steps of configuring on a mobile electronic device a mapping between a plurality of luminance adjustment identifiers and a respective plurality of data sets; tagging a video content segment with a luminance adjustment identifier from the plurality of luminance adjustment identifiers; transmitting from a video server node to the mobile electronic device the video content segment; applying on the mobile electronic device the luminance adjustment identifier to select a data set from the plurality of data sets; loading on the mobile electronic device the selected data set into a lookup table on an integrated circuit; and applying on the integrated circuit data from the loaded data set to adjust luminance of video content from the video content segment as rendered on a display panel of the mobile electronic device.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a communication system in which a mobile electronic device performance optimization method and system are operative in some embodiments of the invention.

FIG. 2 shows the video server node of FIG. 1 in more detail.

FIG. 3 shows the server main memory of FIG. 2 in more detail.

FIG. 4 shows the mobile electronic device of FIG. 1 in more detail.

FIG. 5 shows the device main memory of FIG. 4 in more detail.

FIG. 6 shows the device driver integrated circuit of FIG. 4 in more detail.

FIG. 7 shows the lookup table of FIG. 6 in more detail.

FIG. 8 is a flow diagram of a mobile electronic device performance optimization method in one embodiment of the invention.

### DETAILED DESCRIPTION OF A PREFERRED EMBODIMENT

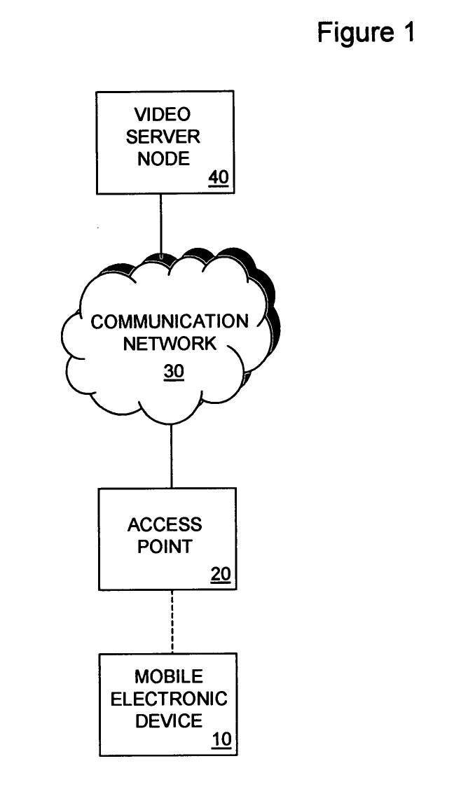

In FIG. 1, a communication system in which a mobile electronic device performance optimization method and system are operative in some embodiments of the invention is shown. The system includes a mobile electronic device 10 coupled to a communication network 30 via a wireless access point 20. The mobile electronic device 10 is a portable electronic device, such as a cellular phone, a digital audio/video player or a PDA, having a wireless communication interface and an LCD. The wireless access point 20 is a network access node, such as a cellular base station, that provides mobile electronic device 10 access via a wireless link to communication network 30. Communication network 30 is a wired telecommunications network, such as a General Packet Radio Service (GPRS) or Internet Protocol (IP) network that includes an arbitrary number of multiplexing nodes, such as switches and routers, and supports data flows between mobile electronic device 10 and video server node 40. Video server node 40 is a computing node adapted to store and deliver video content, such as prerecorded and live feature films, television programs and video clips, to requesting client nodes including mobile electronic device 10. Video content may be delivered wirelessly to mobile electronic device 10 using various technologies, such as MediaFLO®, Digital Video Broadcasting Handheld (DVB-H) and Digital Multimedia Broadcasting (DMB), for example.

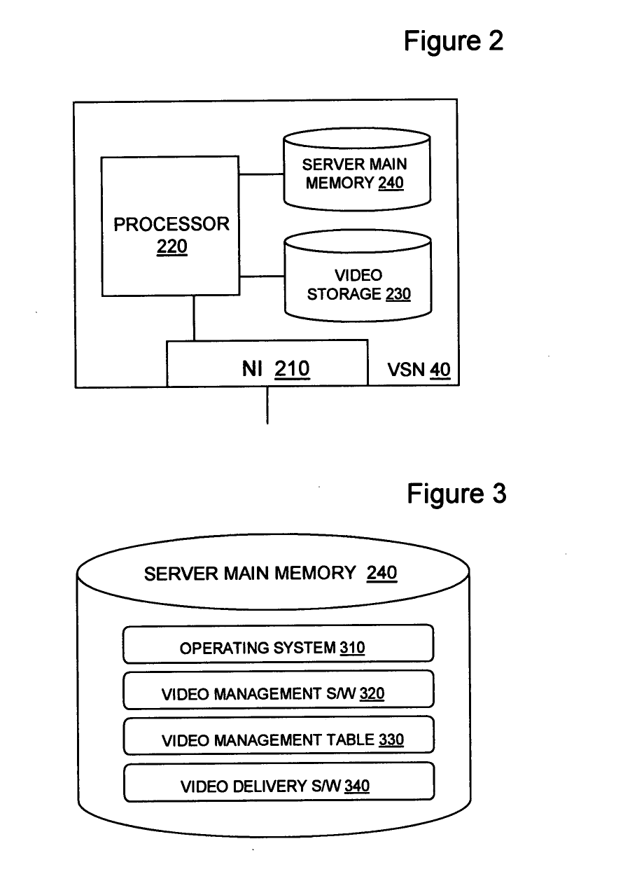

In FIG. 2, video server node 40 is shown in more detail. Node 40 includes a processor 220 communicatively coupled between a server main memory 240 and video storage 230 on the one hand and a network interface 210 on the other. Server main memory 240 and video storage 230 may be implemented in a combination of RAM and ROM, for example. Network interface 210 is a wired communication interface adapted to transmit and receive data from communication network 30. Processor 220 is a general purpose microprocessor adapted to execute software stored in server main memory 240 to deliver video services, including monitoring, examination, processing and delivery of video content stored in video storage 230. For delivery of live video content, video server node may interface with one or more video cameras.

In FIG. 3, server main memory 240 is shown in more detail. Software stored in memory 240 includes an operating system 310, video management software 320 and video delivery software 340, all of which contain instructions executable by processor 220 to deliver video services. Memory 240 also includes a video management table 330 that provides an index to video content stored in video storage 230, such as a mapping of video filenames and memory locations. In an exemplary operation, when video management software 320, running on processor 220, receives a request for video content from mobile electronic device 10, video management software 320 references video management table 330 to determine whether the requested video content is stored in video storage 230. If the requested video content is stored in video storage 230, video management software 320 issues a command to video delivery software 340, also running on processor 220, prompting video delivery software 340 to retrieve the requested video content from video storage 230 for examination, processing and delivery to mobile electronic device 10.

In some embodiments, video delivery software 340 preprocesses video content by determining luminance adjustments adapted to optimize mobile electronic device performance when rendering the video content. Video delivery software 340 determines through examination of video content appropriate levels and application times of luminance adjustment for the video content and the LCD backlight of the mobile electronic device that will display the video content in order to conserve power while maintaining the brightness of the video image as perceived by the user of the client device. This determination may deem a single luminance adjustment level appropriate for an entire video sequence or may deem different luminance adjustment levels appropriate for different segments of a video sequence. Where different luminance adjustment levels are deemed appropriate for different segments, the levels may vary as frequently as every frame of the video sequence or, more typically, less frequently than every frame. In any event, once appropriate luminance adjustment levels and application times have been determined, the segments are tagged with luminance adjustment identifiers and timing data indicative of the determined levels and application times of luminance adjustment. Mappings between video content characteristics and luminance adjustment levels may be stored in video management table 330 or another table within server main memory 240, for example, and referenced by video delivery software 340 to determine appropriate levels of luminance adjustment.

In some embodiments, video delivery software 340 selects luminance adjustment levels from among a small number of discrete luminance adjustment levels that correspond to a small number of discrete luminance adjustment data sets preconfigured on the mobile electronic device that are adopted for loading into a lookup table on the mobile electronic device that will render the video content, and that the luminance adjustment identifiers indicative of the determined luminance adjustment levels that accompany the video segments map to lookup table data sets. It will be appreciated that support for a small number of discrete luminance adjustment levels and a correspondingly small number of luminance adjustment data sets is conducive to standardization of the levels and the contents of the data sets to enable compatibility between video server nodes and mobile electronic devices made by different manufacturers, as well as reduced complexity of software on the mobile electronic devices. Support for a small number of discrete luminance adjustment levels also limits the size of luminance adjustment tags that accompany the video segments. In some embodiments, between four and eight discrete luminance adjustment levels (e.g. two or three bit luminance adjustment identifiers within tags) and between four and eight corresponding luminance adjustment data sets are contemplated.

In some embodiments, video delivery software 340 luminance adjustment tags having luminance adjustment identifiers and timing data indicative of determined levels and application times of luminance adjustment are transmitted before a video sequence, whereas in other embodiments luminance adjustment tags are transmitted contemporaneously with a video sequence. Luminance adjustment tags may be added to system information data, such as alternate audio data, closed caption data, conditional access data, electronic programming guide (EPG) data and service identification data, for example, or may be embedded within video content. The timing data within a luminance adjustment tag may identify, for example, a frame or time offset measured from the beginning of a video sequence when a mobile electronic device should begin to apply a luminance adjustment identifier within the tag. In some embodiments where luminance adjustment tags are transmitted immediately prior to segments of a video sequence to which the tags apply, application times may be implicit and timing data may be omitted from the tags.

In some embodiments, video delivery software 340 determines luminance adjustments for a video sequence “out of band,” that is, independent of download of the video sequence. In these embodiments, video delivery software 340 stores the luminance adjustment identifiers and timing data in memory, such as video storage 230, in association with the video sequence. In other embodiments, video delivery software 340 performs determines luminance adjustments for a video sequence “on the fly,” that is, in connection with download of the video sequence to a requesting mobile electronic device.

As part of processing of video sequences, video delivery software 340 may also perform video encoding functions such as compression of the video sequence.

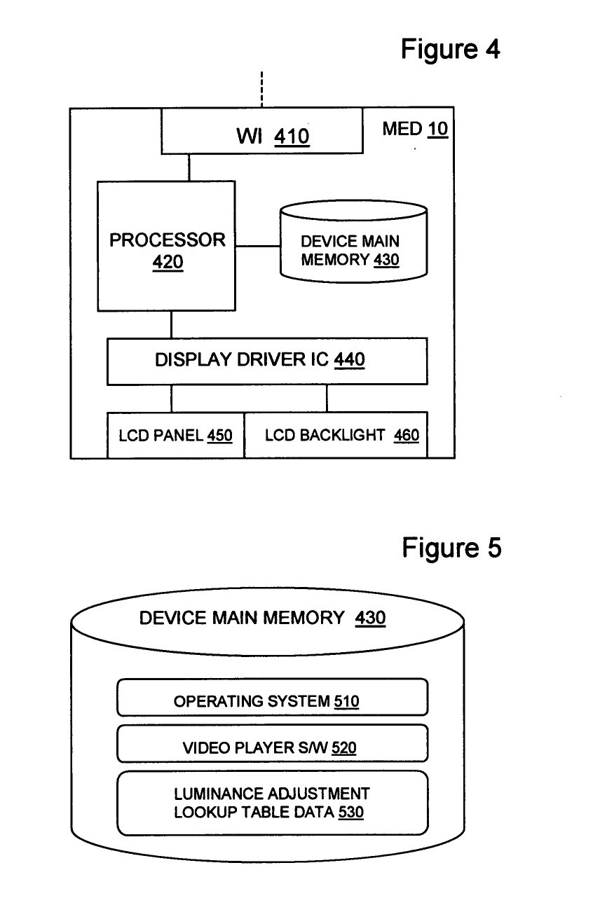

In FIG. 4, mobile electronic device 10 is shown in more detail. Device 10 includes a processor 420 communicatively coupled between a device main memory 430, a display driver integrated circuit 440 and a wireless interface 410. Display driver integrated circuit 440 is communicatively coupled with LCD panel 450 and LCD backlight 460. Device main memory 430 may be implemented in a combination of RAM and ROM, for example. Wireless interface 410 is a communication interface adapted to transmit and receive data via a wireless link established with wireless access point 20. Processor 420 is a general purpose microprocessor adapted to execute software stored in device main memory 430 to provide services supported on device 10, including requesting of video content from video server node 40 and processing and display of video content received from video server node 40 in response to requests. Display driver integrated circuit 440 is an integrated circuit adapted to control the display on LCD panel 450 of video images based on video content received from video server node 40, including adjusting the luminance of the video content as rendered on the LCD panel 450.

In FIG. 5, device main memory 430 is shown in more detail. Software stored in memory 430 includes an operating system 510 and video player software 520, both of which contain instructions executable by processor 420. Memory 430 also includes luminance adjustment lookup table data 530. Luminance adjustment lookup table data 530 includes a plurality of preconfigured luminance adjustment data sets that map to a respective plurality of luminance adjustment identifiers. In some embodiments, a luminance adjustment data set specifies a plurality of gamma correction values for application to a respective plurality of input luminance values when the luminance adjustment level corresponding to the data set is operative.

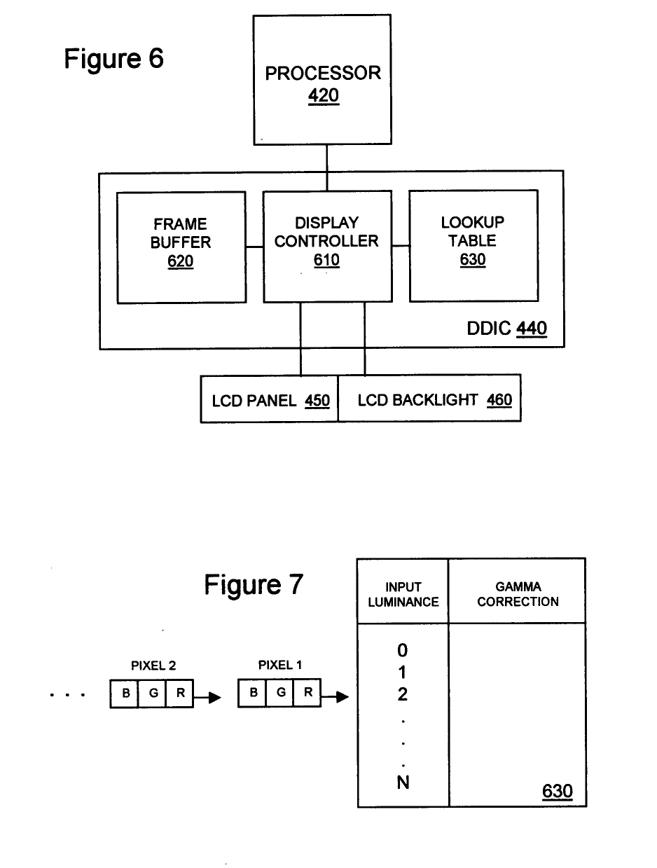

In FIG. 6, device driver integrated circuit 440 is shown in more detail. Device driver integrated circuit 440 includes a display controller 610 coupled between processor 420 on the one hand and LCD panel 450 and LCD backlight 460 on the other. Display controller 610 has access to frame buffer 620 and a luminance adjustment lookup table 630. Display controller 610 performs video control functions in hardwired logic in response to calls and commands received from processor 420.

In an exemplary operation, video player software 520, running on processor 420, requests a video sequence from video server node 40. In response to the request, video player software 520 receives from video server node 40 a video stream including video content and system information for a video sequence. Video player software 520 examines luminance adjustment tags within the video content or system information and, at application times indicated by timing data within the tags loads luminance adjustment data sets from luminance adjustment data 530 that are associated with luminance adjustment identifiers within the tags into luminance adjustment lookup table 630. Lookup table load operations may be accomplished through issuance and execution of calls or commands between video player software 520, operating system 510 and display controller 610, for example. At such application times, video player software 520 also issues calls or commands directly or indirectly to display controller 610 to adjust LCD backlight 460 to a level conformant with luminance adjustment identifiers within the tags. Meanwhile, video player software 520 decodes video content and video content is transmitted to frame buffer 620 for subsequent rendering on LCD panel 450 under the control of display controller 610.

Display controller 610 references luminance adjustment lookup table 630 to adjust luminance of video content as rendered on LCD panel 450. Turning to FIG. 7, lookup table 630 is shown to include table entries formed from loaded luminance adjustment data sets. Entries in table 630 associate input luminance values with gamma correction values. In some embodiments, input luminance values are explicit in table 630. In other embodiments, luminance adjustment data sets are loaded in table 630 such that input luminance values are inferable from memory addresses, and input luminance values are therefore implicit. Naturally, entries in table 630 may include additional fields. In preparation for rendering each video frame stored in frame buffer 620, display controller 610 either directly or indirectly maps red, green and blue input luminance values for each pixel of the frame to a corresponding gamma correction value within table 630. The input luminance value is multiplied by the gamma correction value and, after a voltage correction, is applied to the pixel on LCD panel 450. Display controller 610 simultaneously may execute calls or commands received from processor 420 to appropriately adjust luminance of LCD backlight 460 when rendering the video frame.

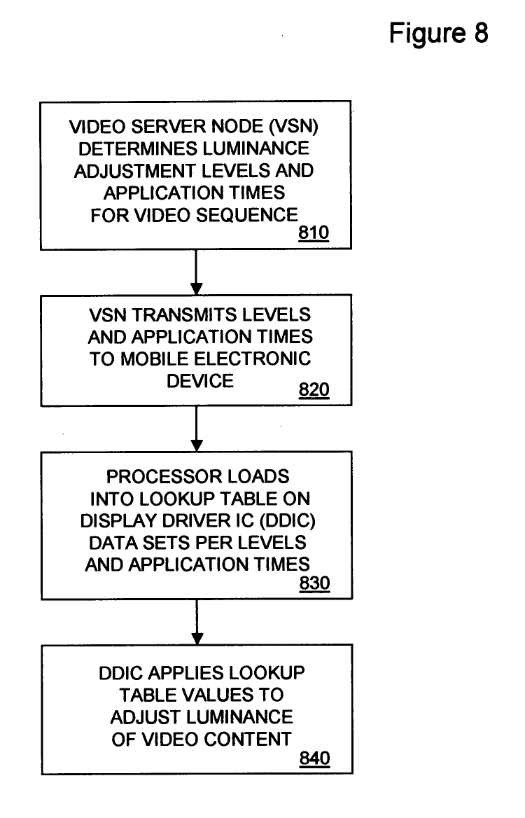

Turning to FIG. 8, a mobile electronic device performance optimization method is shown in one embodiment of the invention. Video server node 40 determines luminance adjustment levels and luminance adjustment level application times for a video sequence (710). This determination may be made “out of band” or “on the fly” and may be applicable to a multi-frame video segment within the video sequence. Video server node 40 transmits the luminance adjustment levels and application times to mobile electronic device 10 (720). This may be done prior or contemporaneously with transmission of video content from the video sequence and may be conveyed in the form of discrete luminance adjustment identifiers and timing data. Processor 420 receives the luminance adjustment levels and application times and, at the application times, loads data sets associated with the levels into luminance adjustment lookup table 630 on display driver integrated circuit 440 (730). Display driver integrated circuit 440 applies values from lookup table 630 to adjust the luminance of video content from the video sequence as rendered on LCD panel 450 (740).

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come with in the meaning and range of equivalents thereof are intended to be embraced therein.

I claim:

1. A mobile electronic device, comprising:
a wireless interface;
a processor adapted to execute software instructions; and
a display driver integrated circuit, wherein the processor is adapted to receive via the wireless interface a luminance adjustment identifier, apply the luminance adjustment identifier to select a data set from a plurality of preconfigured data sets and load the selected data set into a lookup table on the display driver integrated circuit, and wherein the display driver integrated circuit is adapted to apply at least one value from the loaded data set to adjust luminance of video content as rendered on a display panel of the mobile electronic device.

2. The device of claim 1, wherein the processor is further adapted to apply the luminance adjustment identifier to determine luminance of a backlight when the video content is rendered on the display panel.

3. The device of claim 1, wherein the processor is further adapted to receive via the wireless interface timing data associated with the luminance adjustment identifier and apply the timing data to schedule loading of the selected data set into the lookup table.

4. The device of claim 1, wherein the display panel comprises an LCD panel.

5. The device of claim 1, wherein the luminance adjustment identifier maps directly to the selected data set.

6. The device of claim 1, wherein the luminance adjustment identifier is received within service information accompanying the video content.

7. The device of claim 1, wherein the luminance adjustment identifier is embedded within video content.

8. A method for optimizing performance of a mobile electronic device when processing video content, comprising the steps of:
receiving a luminance adjustment identifier;
selecting a data set from a plurality of preconfigured data sets based at least in part on the luminance adjustment identifier;
loading the selected data set into a lookup table on a display driver integrated circuit; and
determining by the display driver integrated circuit the luminance of video content as rendered on a display panel based at least in part on a value from the loaded data set.

9. The method of claim 8, further comprising the step of determining by the display driver integrated circuit the luminance of a display backlight when the video content is rendered on the display panel based at least in part on the luminance adjustment identifier.

10. The method of claim 8, further comprising the steps of:
receiving timing data associated with the luminance adjustment identifier; and
scheduling loading of the selected data set into the lookup table based at least in part on the timing data.

11. The method of claim 8, wherein the display panel comprises an LCD panel.

12. The method of claim 8, wherein the luminance adjustment identifier maps directly to the selected data set.

13. A method for optimizing performance of a mobile electronic device when processing video content, comprising the steps of:
configuring on a mobile electronic device a mapping between a plurality of luminance adjustment identifiers and a respective plurality of data sets;
togging a video content segment with a luminance adjustment identifier from the plurality of luminance adjustment identifiers;
transmitting from a video server node to the mobile electronic device the video content segment;
applying on the mobile electronic device the luminance adjustment identifier to select a data set from the plurality of data sets;
loading on the mobile electronic device the selected data set into a lookup table on an integrated circuit; and
applying on the integrated circuit data from the loaded data set to adjust luminance of video content from the video content segment as rendered on a display panel of the mobile electronic device.

14. The method of claim 13, further comprising the step of applying on the integrated circuit data from the loaded data set to determine luminance of a display backlight when the video content is rendered on the display panel.

15. The method of claim 13, further comprising the steps of:
tagging the video content segment with timing data associated with the luminance adjustment identifier; and
applying the timing data to schedule the loading step.

16. The method of claim 13, wherein the display panel comprises an LCD panel.
